(19) United States
(12) Patent Application Publication
(10) Pub. No.: US 2005/0102908 A1
(43) Pub. Date: May 19, 2005

(54) Multi-functional door

(76) Inventor: William D. Martin, Taylorsville, UT (US)

Correspondence Address: Vaughn W. North;THORPE NORTH & WESTERN, LLP, P.O. Box 1219, Sandy, UT, 84091-1219, US

(21) Appl. No.: 10/951,507

(22) Filed: Sep. 27, 2004

Related U.S. Application Data
(60) Provisional application No. 60/507,228, filed on Sep. 26, 2003.

(51) Int. Cl. E05D 13/00

(52) U.S. Cl. 49/455; 52/455; 52/204.1

(57) ABSTRACT

A method and apparatus providing a multi-functional, integrated security storm door. The multi-functional door includes a door member, an insert frame member, a window member and a security grill. The door member includes an outside surface and an inside surface and a window opening defining a periphery extending between the outside surface and the inside surface. The insert frame member includes an inner surface configured to be positioned at least partially along the periphery of the window opening. The window member includes a window periphery configured to be positioned within the insert frame member. The security grill includes a portion configured to be coupled to the insert frame member. With the arrangement, the security grill and the window member are configured to be commonly supported by the inner surface of the insert frame member.

This application claims the benefit of U.S. Provisional Patent Application No. 60/507,228 filed on Sep. 26, 2003.

### FIELD OF THE INVENTION

The present invention relates generally to main doors for homes or businesses. More particularly, the present invention relates to a door that combines the functions of a security door and a storm door in a single structure.

### BACKGROUND OF THE INVENTION

Security doors have been used for a number of years to provide enhanced protection for homes and businesses, beyond that provided by a conventional main door. These doors are positioned in front of the main door and typically comprise a cage-like structure of wrought iron or other suitable metal. Security doors are often affixed to the outside surface of the main door or to the doorway to swing open and closed as an additional and separate door structure.

Another door complementary to the main door is a storm door. Storm doors are typically used to provide an extra measure of thermal and moisture insulation and often include a removable window pane that is replaced with a screen insert to provide ventilation. As an alternative, storm doors may have a slidable window pane that can be displaced to expose variable amounts of a fixed screen for appropriate ventilation.

Unfortunately, both security doors and storm doors are expensive additions to the main door. Further, the appearance of these doors can also be aesthetically unappealing when affixed to one's home or business. Despite this cost and appearance, governmental agencies, such as the “Housing Authority”, have strong concerns relating to security issues for the people living in the low-income housing and will often specify security doors as required construction. It will be apparent that the cost of security doors and/or storm doors for such projects including thousands of homes governed by the governmental agencies can be of serious concern.

Therefore, it would be advantageous to develop a door system that provides security features and includes some of the functions of a storm door that is cost efficient and aesthetically appealing as well.

### SUMMARY OF THE INVENTION

The present invention relates to a multi-functional security storm door. The multi-functional door includes a door member, an insert frame member, a window member and a security grill integrated into a single structure. The door member includes an outside surface and an inside surface and a window opening defining a periphery extending between the outside surface and the inside surface. The insert frame member includes an inner surface configured to be positioned at least partially along the periphery of the window opening. The window member includes a window periphery configured to be positioned within the insert frame member. The security grill includes a portion configured to be coupled to the insert frame member. With the arrangement, the security grill and the window member are configured to be commonly supported by the inner surface of the insert frame member.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 illustrates a front view of a multi-functional door, depicting the door having an insert assembly positioned in an opening in the door, according to an embodiment of the present invention.

FIG. 2 illustrates a side view of the multi-functional door, depicting a profile of the insert assembly with respect to the door.

FIG. 3 illustrates a cross-sectional view taken along line 3 of FIG. 1 of the multi-functional door, depicting components of the insert assembly, according to an embodiment of the present invention.

FIG. 4 illustrates an enlarged cross-sectional view taken from line 4 in FIG. 1 of the multi-functional door, depicting a lower portion of the insert assembly, according to an embodiment of the present invention.

FIG. 5 illustrates a cross-sectional view of the lower portion of the insert assembly, depicting an embodiment for assembling the insert assembly into the door.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

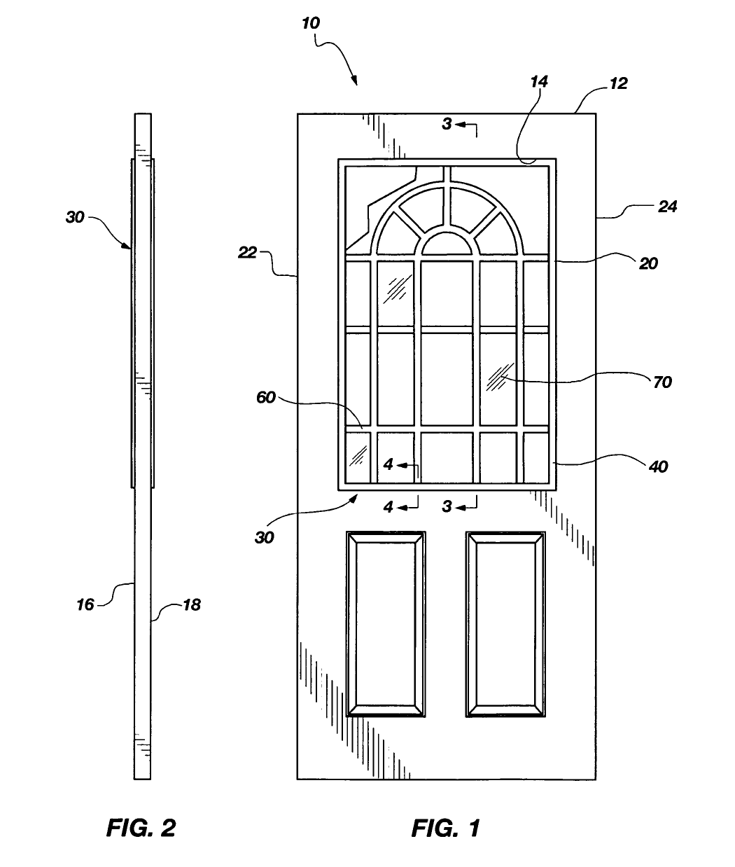

FIGS. 1 and 2 illustrate a multi-functional door 10 configured to serve as a main or primary door of a home, business or any suitable type of dwelling. Such a multi-functional door 10 can function as a security door and a storm door within the same primary door of the dwelling. Specifically, the multi-functional door 10 includes a door member 12 with an opening 14 sized and configured to receive an insert assembly 30. The insert assembly 30 can be secured to the door member 12 and includes various components that function as a storm door as well as provide security and privacy. Such an insert assembly 30 can be compactly designed with a low profile (FIG. 2) with respect to outside 16 and inside 18 surfaces of the door member 12.

The opening 14 in the door member 12 defines a periphery 20 extending between the outside and inside surfaces 16 and 18 of the door member 12. The opening 14 can be centered between first and second sides 22 and 24 of the door member 12 and is preferably formed and positioned within an upper two/thirds of the door member 12. However, the opening 14 can be of any suitable size and may be positioned at any suitable location within the door member 12, including a full length if desired. Such a door member 12 can be a hollow door made from wood or metal or any other suitable materials, composites and/or combination of materials. In addition, the door member 12 can be a solid wood or metal door.

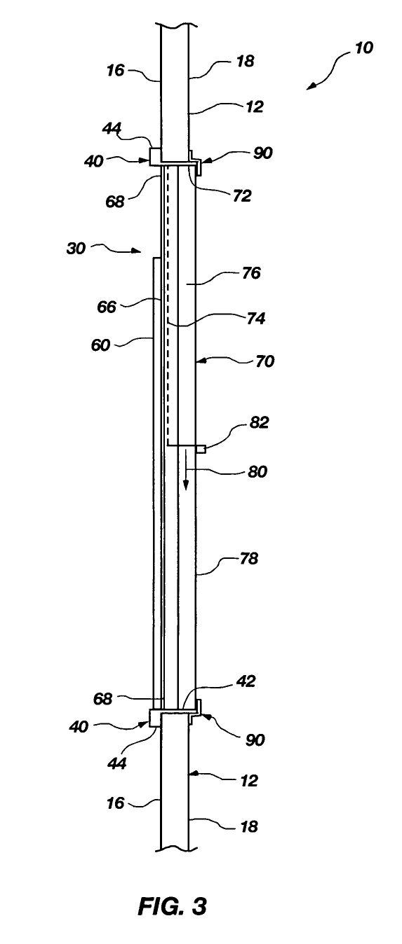

With respect to FIGS. 1 and 3, the insert assembly 30 can include an insert frame member 40, a security grill 60, a privacy screen 66 and a window member 70. The insert frame member 40 can be sized and configured to be positioned within the opening 14 of the door member 12. As depicted, the insert frame member 40 can be generally square or rectangular in shape to correspond with the opening 14 in the door member 12 for facilitating insertion and positioning therein. However, as desired, the opening 14 and insert frame member 40 can include other shapes and configurations that may be round or oval. Such an insert frame member 40 can be configured to house and support the security grill 60, privacy screen 66 and the window member 70.

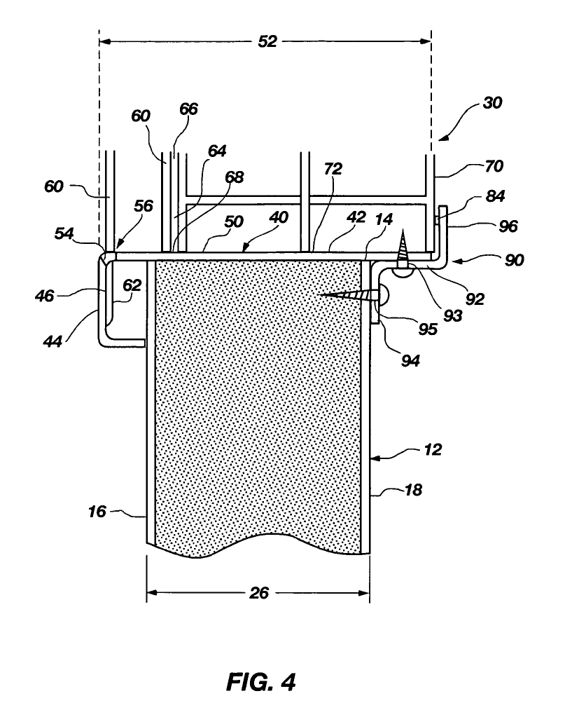

Referring now to FIGS. 3 and 4, the insert frame member 40 can include a housing portion 42 and a hanger extension 44. The hanger extension 44 can be an L-shaped extension or any other suitable shaped extension configured to hang over and be positioned against the outside surface 16 of the door member 12. The hanger extension 44 can be configured to act as a blocking member to properly position the insert assembly 30. The housing portion 42 can be configured to house the components in the insert assembly 30 and can be positioned against the periphery 20 of the opening 14 in the door member 12. The housing portion 42 can include an inner surface 50 configured to support the security grill 60 and the window member 70.

The housing portion 42 can include, but is not limited to, a width 52 slightly larger than a door thickness 26 so as to compactly support each of the security grill 60, privacy screen 66 and window member 70. The housing portion 42 can include openings 54 extending therethrough and defined at a front end portion 56 of the hanger extension 44 to receive grill end portions 62 of the security grill 60. The grill end portions 62 can be welded or fastened by any suitable means to a back surface 46 of the hanger extension 44 while being supported by the inner surface 50 of the housing portion 42. With this arrangement, the welds and/or fasteners fastening the grill end portions 62 to the back surface 46 of the hanger extension are unexposed to minimize unlawful attempts to remove the security grill 60 and to provide a sense of security and a clean finish to the product.

The security grill 60 can include metal elongated bars that include a cross configuration or any suitable design that is aesthetically appealing and provides a security aspect component to the multi-functional door 10. The security grill 60 can be formed of wrought iron or metal and can be powder coated to any desired color. As previously described, the security grill 60 can be positioned and supported on the inner surface 50 of the insert frame member 40 with grill end portions 62 welded to the back surface 46 of the hanger extension 44 of the insert member 40 so that the welds are unexposed.

The privacy screen 66 can be expanded metal screen material or perforated sheet metal with any suitable design configuration and 66 can be sized and configured to be positioned against an inner side 64 of the security grill within the insert assembly 30. As such, peripheral portions 68 of the privacy screen 66 can be welded or fastened to the security grill and/or the inner surface 50 of the housing portion 42. Such a privacy screen 66 can be an optional component in the insert assembly 30 and can serve to minimize visibility through the window member so as to provide privacy as well as security to minimize breaking of glass in the window member 70.

The window member 70 can be a double or single paned insulated window or any other suitable window known in the art positioned and supported within and on the inner surface 50 of the housing portion 42. Typically, the window member 70 is adhesively bonded, fastened and/or welded at various points about a window periphery 72 of the window member 70 to the inner surface 50 of the housing portion 42. Once the window member 70 is positioned and/or secured within the insert frame member 40, an insulative material, such as caulking, can be disposed between any gap between the window member 70 and the housing portion 42 of the insert frame member 40. The window member 70 can also include a screen 74 and an upper window portion 76 and lower window portion 78. The lower window portion 78 can be a fixed window, with the upper window being configured to slide to various open positions toward the lower window portion 78, as indicated by arrow 80, to expose the screen portion 74. In this manner, the multi-functional door 10 can function as a screen door, or storm door to allow the free-flow of air through the window member 70 in the various open positions as desired. Likewise, the upper window portion 76 can be placed in an upward, closed position to insulate and block the free-flow of air through the window member 70. Further, the window member 70 can include a locking mechanism 82 to maintain the upper window portion 76 in the closed and locked position.

A significant advantage of the present invention is the ease of assembly of the integrated door structure. For example, the insert assembly 30 with combined window and security components can be positioned in the opening 14 and secured to the door member 12 as a single step using one or more retainers 90. The retainers 90 can include a Z-shaped cross-sectional configuration with a middle portion 92, a first extension 94 and a second extension 96. The middle portion 92 is sized and configured to be secured to an outer surface 58 of the housing portion 42 that extends beyond the inside surface 18 of the door member 12. The first extension 94 can be configured to extend transverse from the middle portion 92 to be positioned against the inside surface 18 of the door member 12.

The second extension 96 can be configured to extend transverse to the middle portion 92 to extend over a back portion 84 of the window member 70 to block, stabilize and/or retain the window member 70 within the insert assembly 30. The middle portion 92 can include one or more middle portion openings 93 extending therethrough to enable fastening to the housing portion 42. Likewise, the first extension 94 can include one or more first extension openings 95 for fastening the retainers 90 to the inside surface 18 of the door member 12. Such fastening can be accomplished with any suitable fastener such as screws, nuts and bolts.

The retainer 90 can be sized with any suitable dimensions so as to correspond with the dimensions applicable to retain the insert assembly 30 within the door member 12. For example, the retainers 90 can be elongated so that only one retainer is needed per side of the insert assembly 30 to provide sufficient securing strength. On the other hand, multiple retainers can be positioned on each side of the insert assembly 30 to provide the securing strength necessary for maintaining the insert assembly 30 to the door member 12. It is also contemplated the retainers 90 can be limited to two opposing sides of the insert assembly 30, such as the upper and lower sides of the insert assembly 30. With this arrangement, the components of the insert assembly 30 can be pre-assembled with each of the security grill 60, privacy screen 66 and window member 70 secured to the insert frame member 40. As such, the pre-assembled insert assembly 30 functions as a single, integrated insert that can be easily positioned within the opening 14 and then secured to the door member 12 with the retainers 90.

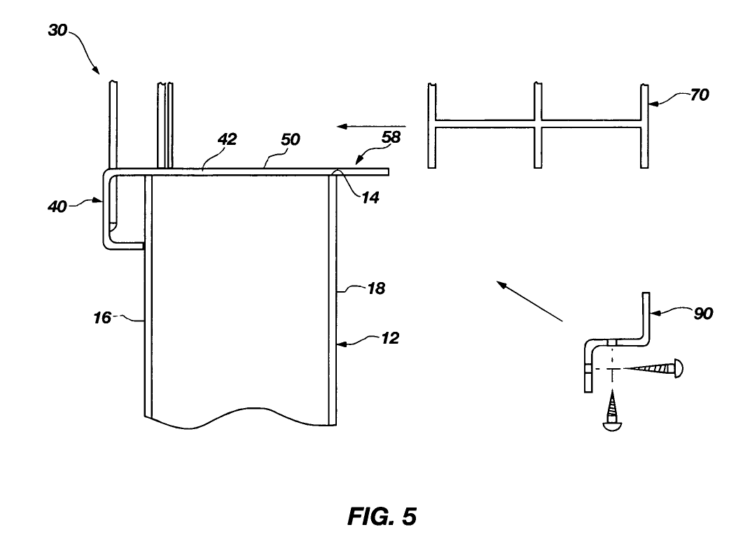

With respect to FIG. 5, in another embodiment, assembly of the insert assembly 30 can be employed without the window member 70 pre-positioned within the insert frame member 40. In particular, the insert assembly 30 can include the security grill 60 and privacy portion 66 mounted to the insert frame member 40 and positioned within the opening 14 from the outside surface 16 of the door member 12. The window member 70 can then be positioned within a rear portion 58 of the housing portion 42 of the insert frame member 40 from the inside surface 18 of the door member 12. If needed, an insulative material, such as caulking, can then be disposed within any air gap between the inner surface 50 of the insert frame member 40 and the window member 70. The retainers 90 can then be secured to the door member 12 and insert frame member 40 to secure the insert assembly 30 within the opening 14 of the door member 12. Such a configuration may be suitable for shipping, wherein the glass portion can be inserted on site to protect it from breakage.

In another embodiment, the insert frame member can include separate and discreet components including a grill support portion and a window support portion each with an inner surface configured to support the security grill and the window support portion. The grill support portion can be configured similar to the hanger extension and serve a similar function as previously described. Likewise, the window support portion can be configured similar to the housing portion of the previous embodiment.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the examples.

1. A multi-functional security storm door, comprising:
a door member having an outside surface and an inside surface, the door member including a window opening defining a periphery extending between the outside surface and the inside surface;
an insert frame member having an inner surface configured to be positioned at least partially along the periphery of the window opening;
a window member having a window periphery configured to be positioned within the insert frame member; and
a security grill having a portion configured to be coupled to the insert frame member;
wherein the security grill and the window member are configured to be commonly supported by the inner surface of the insert frame member.

2. The door of claim 1, wherein the window opening is at least one fourth the size of the door member.

3. The door of claim 1, wherein the opening is selected from a group of configurations including rectangular, round, and oval.

4. The door of claim 1, wherein the insert frame member is any shape corresponding to the shape of the window.

5. The door of claim 1, wherein the insert frame member is configured to receive and support a security grill.

6. The door of claim 1, wherein the insert frame member is configured receive and to support a privacy screen.

7. The door of claim 1, wherein the insert frame member includes a housing portion configured to house other components of the insert frame member.

8. The door of claim 7, wherein the window member is supported with an inner surface of the housing.

9. The door of claim 1 further comprising, the insert frame member includes a hanger extension configured to hang over and be positioned against the outside surface of the door member.

10. The door of claim 9, wherein the hanger extension has an L-shaped cross section.

11. The door of claim 9, wherein the hanger extension is shaped such that it is suitable for hanging over and being positioned against the door member.

12. The door of claim 9, wherein the hanger extension is configured to act as a blocking member to properly position the insert frame at a limiting position when abutting against the blocking member.

13. The door of claim 1, wherein the insert frame member comprises separate and discrete components for supporting the security grill and the window member.

14. The door of claim 1, wherein the insert frame member combined with the window member and the security grill is secured to the door member using at least one retainer.

15. The door of claim 14, further comprising a Z-shaped retainer having a first extension, middle portion, and second section;
wherein the first extension is configured to extend transverse from the middle portion to be positioned against the inside surface of the door member;
wherein the middle portion is sized and configured to be secured to an outer surface of the housing portion extending beyond the inside surface of the door member; and
wherein the second extension can be configured to extend transverse to the middle portion extending over a back portion of the window member to block, stabilize and/or retain the window member within the insert assembly.

16. A multi-functional security storm door, comprising:
a door member having an outside surface and an inside surface, the door member including a window opening defining a periphery extending between the outside surface and the inside surface;
an insert frame member having a grill support portion and a window support portion, the insert frame member having an inner surface configured to be positioned at least partially along the periphery of the window opening;
a window member having a window periphery configured to be positioned within the window support portion of the insert frame member; and
a security grill having a portion configured to be coupled to the grill support portion of the insert frame member;
wherein the security grill and the window member are configured to be commonly supported by the inner surface of the insert frame member.

17. The door of claim 16, wherein the window opening is at least one fourth the size of the door member.

18. The door of claim 16, wherein the opening is selected from a group of configurations including rectangular, round, and oval.

19. The door of claim 16, wherein the insert frame member is any shape corresponding to the shape of the window.

20. The door of claim 16, wherein the insert frame member is configured to receive, support, and facilitate a sliding window and screen of a storm door.

21. The door of claim 16, wherein the insert frame member is configured to receive and to support a privacy screen.

22. The door of claim 16, wherein the insert frame member includes a housing portion configured to house other components of the insert frame member.

23. The door of claim 22, wherein the window member is supported with an inner surface of the housing.

24. The door of claim 16, further comprising, the insert frame member includes a hanger extension configured to hang over and be positioned against the outside surface of the door member.

25. The door of claim 24, wherein the hanger extension has an L-shaped cross section.

26. The door of claim 24, wherein the hanger extension is shaped such that it is suitable for hanging over and being positioned against the door member.

27. The door of claim 24, wherein the hanger extension is configured to act as a blocking member to properly position the insert frame at a limiting position when abutting against the blocking member.

28. The door of claim 16, wherein the insert frame member comprises separate and discrete components for supporting the security grill and the window member.

29. The door of claim 16, wherein the insert frame member combined with the window member and the security grill is secured to the door member using at least one retainer.

30. The door of claim 29, further comprising a Z-shaped retainer having a first extension, middle portion, and second section;
wherein the first extension is configured to extend transverse from the middle portion to be positioned against the inside surface of the door member;
wherein the middle portion is sized and configured to be secured to an outer surface of the housing portion extending beyond the inside surface of the door member; and
wherein the second extension can be configured to extend transverse to the middle portion extending over a back portion of the window member to block, stabilize and/or retain the window member within the insert assembly.
